(19) United States
(12) Patent Application Publication
(10) Pub. No.: US 2005/0032411 A1
(43) Pub. Date: Feb. 10, 2005

(54) Low profile cable connector with hybrid latch

(76) Inventors: Glen Gutgold, Hummelstown, PA (US); Tracy L. Smith, Harrisburg, PA (US); Eric N. Fischer, Walnut Creek, CA (US)

Correspondence Address: Robert Kapalka;Tyco Electronics Corporation, Suite 140, 4550 New Linden Hill Road, Wilmington, DE, 19808, US

(21) Appl. No.: 10/635,107

(22) Filed: Aug. 6, 2003

(51) Int. Cl. H01R 13/627

(52) U.S. Cl. 439/362

(57) ABSTRACT

A low profile cable connector includes a mating connector face, and first and second lateral sides extending from said mating connector face. One of the first and second sides comprises a bail latch retainer thereon, and a jack screw latch is located adjacent the other of said first and second sides. The cable exit extends from one of the first and second sides at an angle to the mating connector face. The bail latch retainer comprises a bail latch slot, and the jack screw extends through a top surface of the connector. The connector is defined by first and second backshells joined to one another.

### BACKGROUND OF THE INVENTION

The invention relates generally to electrical cable assemblies, and more particularly, to latching assemblies for ensuring a proper connection of a cable to a complementary mating connector.

Networked electronic systems often include a number of devices communicating with other devices through a number of associated electrical cables. Managing the number of cable connections in, for example, a telecommunications system, can be challenging.

Typically, cable connectors have a connector mating face and a latch to ensure proper engagement of the connector mating face to a complementary connector. One type of latching structure is a bail-type latch having a wire formed in a loop and pivotally mounted to the base of a connector housing. The wire is movable between an open position which allows mating of the cable connector and the mating connector, and a latched position embracing the cable connector and the mating connector and securing the connectors together. Typically, two bail latches are employed, with one of the bail latches located on either side of the connector. See, for example, U.S. Pat. No. 5,924,886.

Another type of latching structure involves the use of jack screws. Typically, the cable connector includes first and second jack screws positioned along each side of the cable connector which engage a mating connector via threaded engagement of the jackscrews to the mating connector. See, for example, U.S. Pat. No. 6,273,742.

Conventionally, the connector mating face of a cable connector is substantially perpendicular to the axis of the cable where it engages the connector, and the cable exits the connector in a central portion of the connector. The cable connector is therefore generally symmetrical and both sides of the cable connector are generally accessible to operate the bail latches or the jack screws, depending on the type of connector. The perpendicular orientation of the cable and the connector mating face, however, can occupy a considerable amount of space in the vicinity of a switching device to which numerous cables are connected. Thus, it is now desirable to reduce the profile of the cable connections by orienting the cable axis where it is connected to the cable connector at an oblique angle to, or even parallel to, the mating connector face of the cable connector.

However, the reduced profile cable connectors are problematic for known latching assemblies. Because the cable exits one side of the connector instead of in the center of the connector, the use of a jack screw on the cable exit side requires the that the cable be split around the jack screw, which complicates the construction of the cable connector and introduces potential reliability issues into the cable connection. Also, the asymmetry of the reduced profile cable connector requires a greater latching force on the side of the cable connector opposite the cable exit side, thereby rendering bail latches more difficult to latch and unlatch.

Still another type of latching structure includes integral squeeze to release latches in the cable connector. The integral latches, however, are sometimes not properly engaged, and it is not always apparent from visual inspection of the connector whether or not the cable is properly connected.

Known latch assemblies are therefore inadequate for reduced profile cable connectors.

### BRIEF DESCRIPTION OF THE INVENTION

In an exemplary embodiment, a low profile cable connector is provided. The connector comprises a mating connector face, and first and second lateral sides extending from the mating connector face. One of the first and second sides comprises a bail latch retainer thereon, and a jack screw latch is located adjacent the other of the first and second sides.

Optionally, a cable exit extends from one of the first and second sides at an angle to the mating connector face. The bail latch retainer comprises a bail latch slot, and the jack screw extends through a top surface of the connector. The cable connector is defined by first and second backshells joined to one another, and one of the first and second backshells includes the bail latch retainer formed integrally therewith.

According to another exemplary embodiment, a low profile cable connector comprises a mating connector face, first and second lateral sides extending from the mating connector face, and a cable exit extending from one of the first and second sides. The first side comprises a bail latch retainer thereon, and a jack screw latch located adjacent the second side.

In another exemplary embodiment, a low profile cable connector comprises a housing defining a mating connector face extending opposite a sloped top surface, first and second lateral sides extending from the mating connector face, and a cable exit extending from one of the first and second sides in a direction parallel to the top surface. The first side comprises a bail latch retainer thereon, and a jack screw latch is located adjacent the second side and extends above the sloped surface.

### BRIEF DESCRIPTION OF THE DRAWINGS

FIG. 1 is a perspective view of a cable connector assembly formed in accordance with an embodiment of the present invention.

FIG. 2 is another perspective view of the cable connector shown in FIG. 1.

FIG. 3 is a top plan view of the cable connector shown in FIGS. 1 and 2.

FIG. 4 is an end view of the cable connector shown in FIGS. 1-3.

FIG. 5 is a side elevational view of the cable connector shown in FIGS. 1-4.

FIG. 6 is a top plan view of another embodiment of a cable connector formed in accordance with an embodiment of the present invention.

FIG. 7 is a side elevational view of the cable connector shown in FIG. 6.

FIG. 8 is an end view of the cable connector shown in FIGS. 6 and 7.

### DETAILED DESCRIPTION OF THE INVENTION

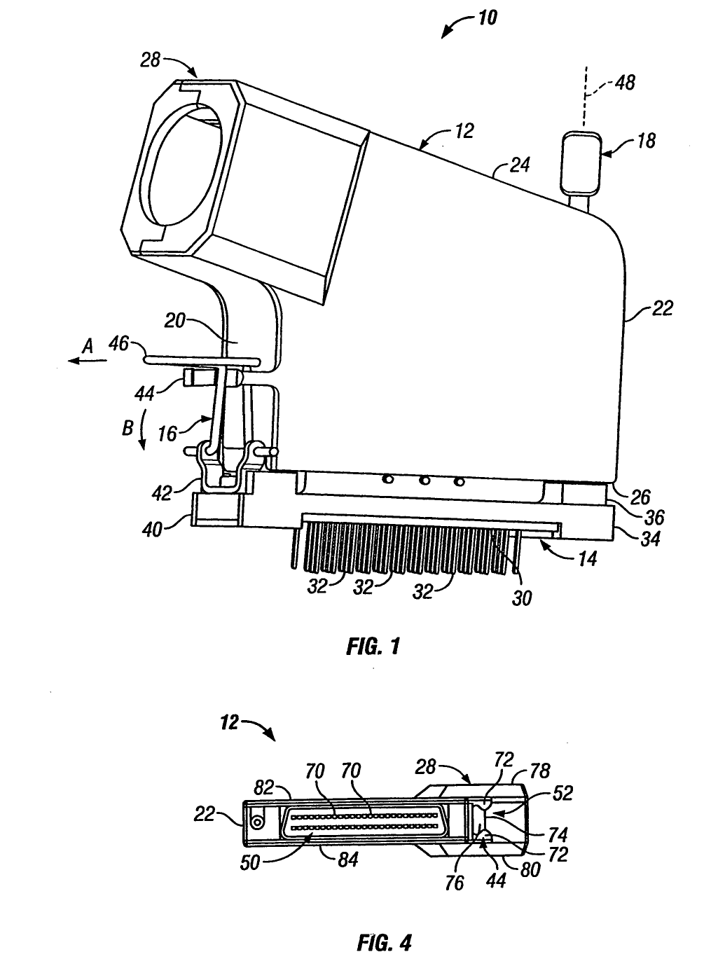

FIG. 1 is a perspective view of an exemplary low profile cable connector assembly 10 formed in accordance with an embodiment of the present invention. The connector assembly 10 includes a cable connector 12 and a mating connector 14 engaged to one another in a mated position via hybrid latching features including a bail latch 16 adjacent a first side 20 of the cable connector 12 and a jack screw 18 adjacent a second side 22 of the cable connector 12 opposite the first side 20. A top surface 24 of the cable connector 12 is sloped or angled relative to a bottom surface 26 of the cable connector 12. A cable exit 28 is formed in the cable connector 12 and extends from the first side 20 of the cable connector 12 in a direction parallel to the sloped top surface 24. As such, the cable exit 28 is oriented at an oblique angle relative to the mating connector 14 to reduce the profile of the connector assembly 10 in use. In an illustrative embodiment, the cable exit 28 overhangs the first side 20 of the cable connector 12 and the bail latch 16.

The mating connector 14 is a known connector having a base 30 and a plurality of terminal pins 32 depending therefrom and in electrical contact with a mating face (not shown in FIG. 1) of the cable connector 12. One end 34 of the base 30 includes a latch block 36, while the opposite end 40 of the base includes a bail latch mount 42 coupled thereto via threaded engagement. The bail latch 16 is pivotally mounted to the bail latch mount 42, and the bail latch 16 interfaces with a bail retainer 44 on the first side 20 of the cable connector 12 to latch the cable connector 12 to the mating connector 14 on the end 40 of the base 30. The jack screw 18 is threadably engaged to the latch block 36 to latch the cable connector 12 to the mating connector 14 on the end 34 of the base 30.

In an exemplary embodiment, the mating connector 14 is a known connector such as the AMP brand printed circuit board connector having part number 786554-5 and available from Tyco Electronics of Harrisburg, Pa. It is contemplated, however, that other mating connectors may be employed in lieu of the AMP connector described above.

In an illustrative embodiment, the bail latch 16 is a wire loop fabricated from known materials by known manufacturing techniques. The ends of the bail latch 16 are coupled to the bail latch mount 42 so that the bail latch 16 is pivotal about its lower ends. When the bail latch 16 is extended in substantially a vertical position alongside the first side 20 of the cable connector 12, the bail latch 16 may be retained by the bail latch retainer 44 as illustrated in FIG. 1. In the latched position, a bail latch handle 46 extends outwardly substantially perpendicularly to the first side 20 of the cable connector 12, thereby providing visual and tactile indication that the cable connector 12 and the mating connector 14 are properly engaged.

The handle portion 46 may be pulled outward in the direction of arrow A to release the bail latch 16 from the bail latch retainer 44 to an open position (not shown). Once in the open position, the bail latch 16 may be pivoted about the bail latch mount 42 in the direction of arrow B wherein the cable connector 12 and the mating connector 14 may be mated or unmated as desired.

While one exemplary bail latch 16 has been described and illustrated, it is understood that other shapes, configurations, and types of bail latches familiar to those in the art may be employed in alternative embodiments without departing from the scope of the present invention.

A known jack screw 18 is provided adjacent the second side 22 of the cable connector 20. The jack screw 18 extends above the top surface 24 of the cable connector 12 for clear access thereto, and by rotating the jack screw about its axis 48, the jack screw 18 may be securely mated or unmated to the mating connector 14, and more specifically to the latch block 32, to mate and unmate the cable connector 12 to and from the end 34 of the mating connector 14.

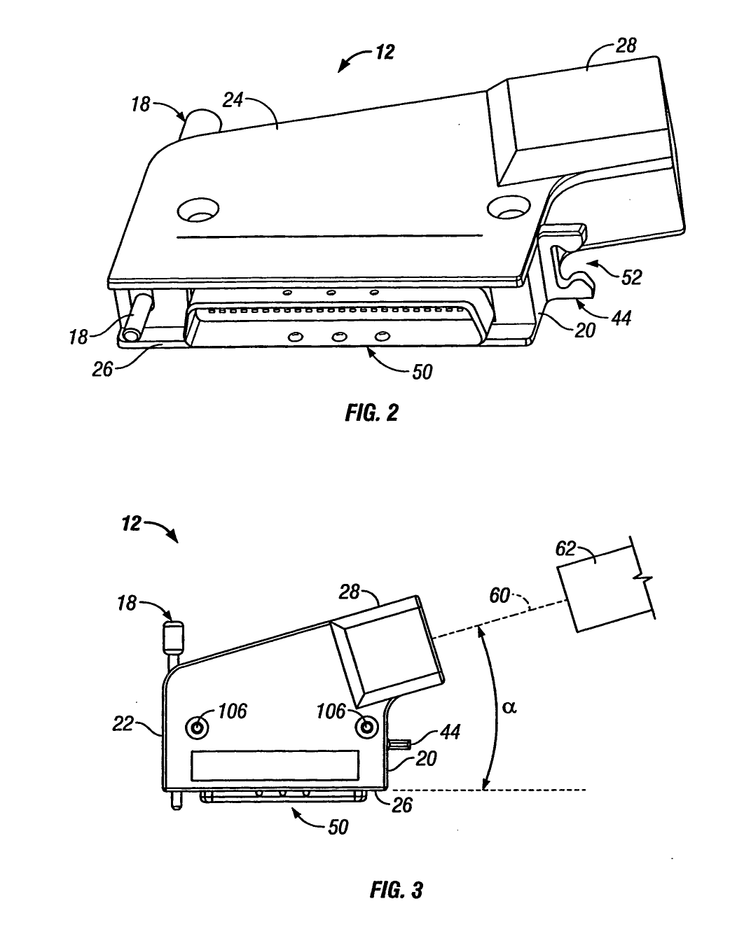

FIG. 2 illustrates the cable connector 12 with the mating connector 14 (shown in FIG. 1) removed. The bottom surface 26 of the cable connector 12 includes a mating connector face 50 adapted for connection to the mating connector 14. The bail latch retainer 44 projects outwardly from the first side 20 of the cable connector 12 and includes a slot 52 formed therein for receiving the bail latch 16 (shown in FIG. 1). The jack screw 18 extends completely through the cable connector from the top surface 18 to the bottom surface 26, and the cable exit 28 extends from the first side 20 of the cable connector 12 above the bail latch retainer 44.

FIG. 3 is a top plan view of the cable connector 12 illustrating the cable exit 28 extending along an axis 60 at an angle α with respect to a plane containing the bottom surface 26 or the mating connector face 50. In an exemplary embodiment, the angle α is about 15°, although it is understood that a could be a greater or lesser angle (including a 0° angle or a parallel orientation with respect to the bottom surface 26 and the mating connector face 50) in an alternative embodiment without departing from the scope of the present invention. The angle α provides for a low profile of the cable connector 12 in use in comparison to conventional cable connectors having straight cable exits from the mating face 50 (i.e., an α value of approximately 90° in FIG. 3}.

The cable exit 28 is configured to receive an end of a cable 62 having a number of conductors therein. The conductors in the cable 62 are terminated within the cable connector 12 according to a known process to establish electrical connection between the cable conductors and contacts associated with the mating connector face 50 as those in the art will appreciate. Once terminations are made, the cable 62 exits the cable connector 12 at the angle α along the axis 60 to establish a low profile cable connection.

The bail latch retainer 44 projects outwardly in substantially perpendicular fashion from the first side 20 of the cable connector 12 and forms a hook for latching of the bail latch 16 (shown in FIG. 1) adjacent the first side 20. The jack screw 18 extends adjacent and substantially parallel to the second side 22 of the cable connector 12.

FIG. 4 is an end view of the cable connector 12 illustrating the mating connector face 50. In an exemplary embodiment, the mating connector face 50 includes a number of pin receptacles 70 for receiving contacts of the mating connector 14 (shown in FIG. 1). It is appreciated that while one exemplary mating face 50 is described, the cable connector 12 may include a variety of configurations of mating faces to interface with a variety of different mating connectors.

The bail latch retainer 44 includes inwardly facing barbs 72 to define a slot 52 therebetween having a narrow neck portion 74 opening into a larger head portion 76 for receiving the bail latch 16. The cable exit 28 extends opposite the second side 22 of the cable assembly 12, and the outer walls 78 and 80 of the cable exit 28 are outwardly stepped from the outer walls 82, 84 of the remainder of the cable connector 12.

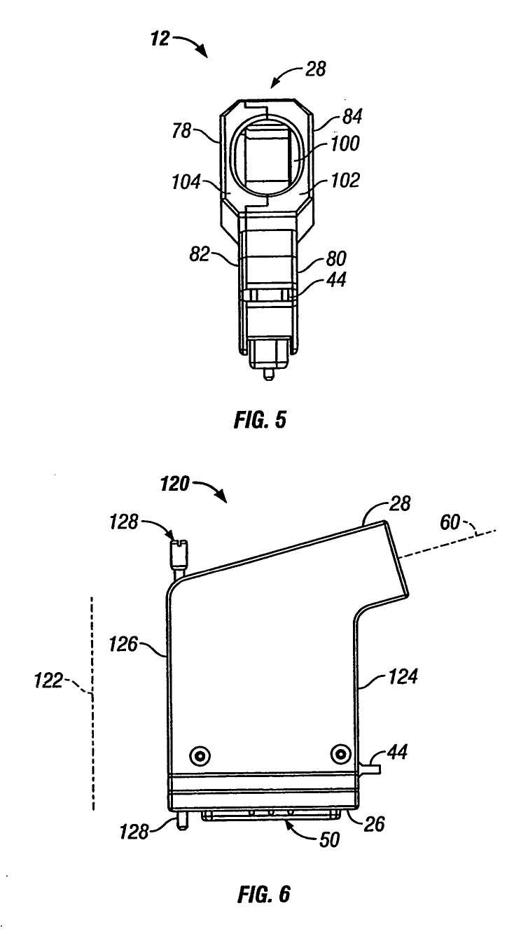

FIG. 5 is a side elevational view of the cable connector 12 illustrating an elliptical or oval-shaped opening 100 in the cable exit 28 for accommodating the cable 62 (shown in FIG. 3). It is appreciated that the cable exit opening 100 may be otherwise shaped as appropriate for different types of cable.

Also, and as illustrated in FIG. 5, the cable connector 12 is formed from two housing backshells 100, 102 joined to one another. That is, the backshell 102 includes outer walls 78 and 82, while backshell 104 includes outer walls 80 and 84, with each of the backshells 102 and 104 defining approximately one half of the opening 100. In one embodiment, the bail latch retainer 44 is formed integrally with only one of the backshells 102, although it is contemplated that the backshells 102 and 104 could be collectively defined by the combination of backshells 102 and 104. In one embodiment the backshells 102 and 104 are formed in a known die cast process, and include internal features therein for terminating the conductive members of a cable, and strain relief features, such as mechanical staple strain relief, familiar to those in the art. In alternative embodiments, the backshells 102 and 104 could be otherwise formed according to known processes and techniques.

The backshells 102 and 104 are fastened together with known fasteners, such as screws 106 (shown in FIG. 3). In alternative embodiments, welded connections, riveted connections, and other known connection schemes may be employed for joining the backshells 102 and 104.

FIG. 6 is a top plan view of another embodiment of a cable connector 120 formed in accordance with an embodiment of the present invention. Cable connector 120 is constructed similarly to cable connector 12 (shown in FIGS. 1-5 and described above) except as noted below.

Comparing FIGS. 6 and 3, it is seen that cable connector 120 has a higher profile along an axis 122 extending substantially parallel to a first and second side 124, 126, respectively, of the cable connector 120. The higher profile permits placement of a printed circuit board (not shown) within the cable connector 120 which, in turn, facilitates use of a 75 ohm, DS-3 coaxial cable to be connected to the cable connector 120 via the cable exit 28 along an axis 60. Like the cable connector 12, the axis 60 extends at approximately a 15° angle with respect to a plane containing the bottom surface 26 or the mating connector face 50.

The bail latch retainer 44 projects outwardly from the second side 124 of cable connector 120 for engagement with the bail latch 16 (shown in FIG. 1) of the mating connector 14 (also shown in FIG. 1). A known jack screw 128 extends through the cable connector 120 adjacent and substantially parallel to the second side 126 of the cable connector 12, albeit with a greater length than the jack screw 18 (shown in FIGS. 1-3) to span the additional profile of the cable connector 120.

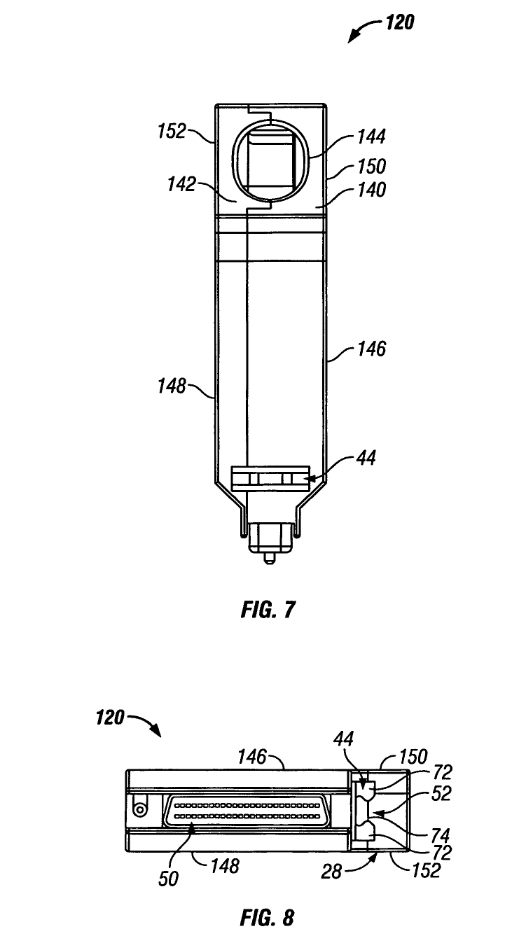

FIGS. 7 and 8 are a side elevational view and an end view of the cable connector shown 120, respectively. The cable connector 120 is fabricated from opposite housing backshells 140 and 142 according to a die casting process, although it is appreciated that other fabrication methods may be employed. The backshells 140 and 142 define an opening 144 for accepting a cable (not shown in FIGS. 7 and 8).

The bail latch retainer 44 includes first and second barbs 72 defining a neck portion 72 of a bail retaining slot 52 as described above. The cable exit 28 and the remainder of the cable connector 120 include substantially flush outer walls 146-152, and the mating connector face 50 extends substantially equidistant from the outer walls 146 and 148.

A low profile cable connector is therefore provided with secure latching. Visual and tactile indication of proper engagement is provided with a bail latch on the side of the cable connector and the jack screw provides secure connection and accessibility through the top of the cable connector. Latching is therefore provided without introducing substantial additional cost to the cable connection, and while providing for engagement with known mating connectors. Secure and reliable electrical connections may therefore be established in a more compact and more economical cable connector.

While the invention has been described in terms of various specific embodiments, those skilled in the art will recognize that the invention can be practiced with modification within the spirit and scope of the claims.

1. A low profile cable connector assembly comprising:
a first connector comprising a base and a pivotally mounted bail latch, said bail latch movable relative to said base between a latched position and an unlatched position; and
a cable connector comprising a mating connector face, and first and second lateral sides extending from said mating connector face;
wherein one of the first and second sides of said cable connector comprises a bail latch retainer thereon, said bail latch retainer configured to receive said pivotally mounted bail latch when said bail latch is moved relative to the mating connector face to said latched position; and
a jack screw latch located adjacent the other of said first and second sides of said cable connector.

2. A low profile cable connector assembly in accordance with claim 1 wherein said cable connector further comprises a cable exit, said cable exit extending from one of said first and second sides.

3. A low profile cable connector assembly in accordance with claim 1 wherein said cable connector further comprises a cable exit, said cable exit extending at an oblique angle to said mating connector face.

4. A low profile cable connector assembly in accordance with claim 1 wherein said bail latch retainer comprises a bail latch slot having inwardly facing barbs defining a slot therebetween.

5. A low profile cable connector assembly in accordance with claim 1, further comprising a cable exit extending from said first side, said bail latch retainer comprising a hook located on said first side.

6. A low profile cable connector assembly in accordance with claim 1 wherein said cable connector includes a sloped top surface, said jack screw extending through said top surface.

7. A low profile cable connector assembly in accordance with claim 1, said cable connector defined by first and second backshells joined to one another, one of said first and second backshells having said bail latch retainer formed integrally therewith.

8. A low profile cable connector assembly comprising:
a mating connector comprising a base and a pivotally mounted bail latch; and
a cable connector comprising a mating connector face, first and second lateral sides extending from said mating connector face, and a cable exit extending from one of said first and second sides;
wherein said first side of said cable connector comprises a bail latch retainer thereon, said bail latch retainer extending substantially perpendicular to said first side and defining a slot extending substantially parallel to said mating connector face, said slot configured to receive said bail latch when said cable connector is mated to said mating connector and when said bail latch is pivoted about said base to a latched position; and
a jack screw latch located adjacent said second side of said cable connector.

9. A low profile cable connector assembly in accordance with claim 8 wherein said cable exit extends at an oblique angle to said mating connector face.

10. A low profile cable connector assembly in accordance with claim 9 wherein said angle is approximately 15°.

11. A low profile cable connector assembly in accordance with claim 8 wherein said bail latch retainer comprises a slot having a neck portion and a head portion.

12. A low profile cable connector assembly in accordance with claim 8 wherein said cable connector further comprises a sloped top surface, said jack screw extending through said top surface.

13. A low profile cable connector assembly in accordance with claim 1, said cable connector defined by first and second backshells joined to one another, one of said first and second backshells having said bail latch retainer formed integrally therewith.

14. A low profile cable connector assembly comprising:
a first connector comprising a base and a pivotally mounted bail latch; and
a cable connector comprising a housing defining a mating connector face extending opposite a top surface which is sloped relative to said mating connector face, first and second lateral sides extending from said mating connector face, and a cable exit extending from one of said first and second sides in a direction parallel to said top surface;
wherein said first side of said cable connector comprises a bail latch retainer thereon, said bail latch retainer comprising a hook which receives said pivotally mounted bail latch as said bail latch is moved relative to said base and moved relative to said housing when said first connector and said cable connector are mated; and
wherein a jack screw latch is located adjacent said second side of said cable connector, said jack screw extending above said sloped surface of said housing.

15. A low profile cable connector assembly in accordance with claim 14 wherein said sloped top surface extends from said housing at an oblique angle relative to said mating connector face.

16. A low profile cable connector assembly in accordance with claim 15 wherein said angle is approximately 15°.

17. A low profile cable connector assembly in accordance with claim 14 wherein said bail latch retainer comprises a bail latch slot.

18. A low profile cable connector assembly in accordance with claim 14, said housing defined by first and second backshells joined to one another, one of said first and second backshells having said bail latch retainer formed integrally therewith.

19. A low profile cable connector assembly in accordance with claim 14 wherein said bail latch retainer extends beneath said cable exit on said first side.

20. A low profile cable connector assembly in accordance with claim 14 wherein said cable exit has an oval shape.
